(19) United States
(12) Patent Application Publication
(10) Pub. No.: US 2019/0313587 A1
(43) Pub. Date: Oct. 17, 2019

(54) Urban Greenhouse Designed for High Crop Production

(71) Applicant: Gerald R. Palmer, Phoenix, AZ (US)

(72) Inventor: Gerald R. Palmer, Phoenix, AZ (US)

(21) Appl. No.: 16/383,631

(22) Filed: Apr. 14, 2019

Related U.S. Application Data
(60) Provisional application No. 62/657,755, filed on Apr. 14, 2018.

(51) Int. Cl. A01G 9/14; A01G 9/18; A01G 9/24

(52) U.S. Cl. CPC A01G 9/1407; A01G 9/247; A01G 9/18; A01G 9/1438

(57) ABSTRACT

An urban greenhouse designed for improved crop production is an enclosed space with a frost cover, mesh cover, liner, drain valve, mulch, and structural framework for gardening. It includes a roll up pipe, CO₂ enhancement of the ambient air around the plants, an insulation board, and an irrigation system.

### CROSS REFERENCE TO RELATED APPLICATIONS

This application claims the benefit of U.S. provisional patent application No. 62/657,755 filed on Apr. 14, 2018. The provisional application is incorporated by reference herein.

### STATEMENT REGARDING FEDERALLY SPONSORED RESEARCH OR DEVELOPMENT

Not applicable.

### REFERENCE TO SEQUENCE LISTING, A TABLE, OR COMPUTER PROGRAM LISTING

Not applicable.

### BACKGROUND OF THE INVENTION

### (1) Field of the Invention

This invention is directed toward equipment to facilitate gardening in urban locations, in particular, in settings that are physically adjacent to an urban house or apartment.

### (2) Description of Related Art

US publication number 20070151150 discusses a gardening box with a protective fence and a tub to hold soil. U.S. Pat. No. 8,839,552 discloses a tub for soil, and various features for a water line/sprinkler. U.S. Pat. No. 4,685,246 discloses a sub-dividing portable box garden.

The above disclosures do not disclose a design that is designed to provide enhanced production of food in a small area, immediately adjacent to an urban building or urban wall. Also missing is insect protection, frost protection, shade protection, and improving growth through the use of an enriched CO₂ atmosphere around the plants.

### BRIEF SUMMARY OF THE INVENTION

As seen in FIGS. 1-2, the urban greenhouse design is an enclosed space with a frost cover, mesh cover, liner, drain valve, mulch, and structural framework for gardening. It also includes a roll up pipe, CO₂ enhancement of the ambient air around the plants, an insulation board, and an irrigation system.

### BRIEF DESCRIPTION OF THE SEVERAL VIEWS OF THE DRAWING(S)

FIG. 1 shows an end elevation view of the embodied invention.

FIG. 2 shows a front elevation view of the embodied invention.

### DETAILED DESCRIPTION OF THE INVENTION

An important goal of the disclosed invention is to create a raised garden utilizing mulch, or a mulch in combination with soil, in an enclosed environment. The garden is surrounded by a four sided box in combination with a lower plastic liner and an upper plastic cover. Alternately, it could be a three sided enclosure that is adjacent to a wall, with a lower plastic liner and an upper plastic cover.

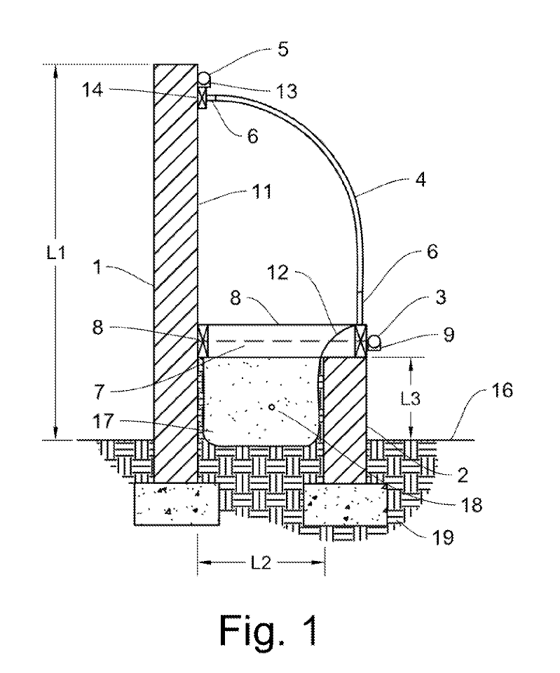

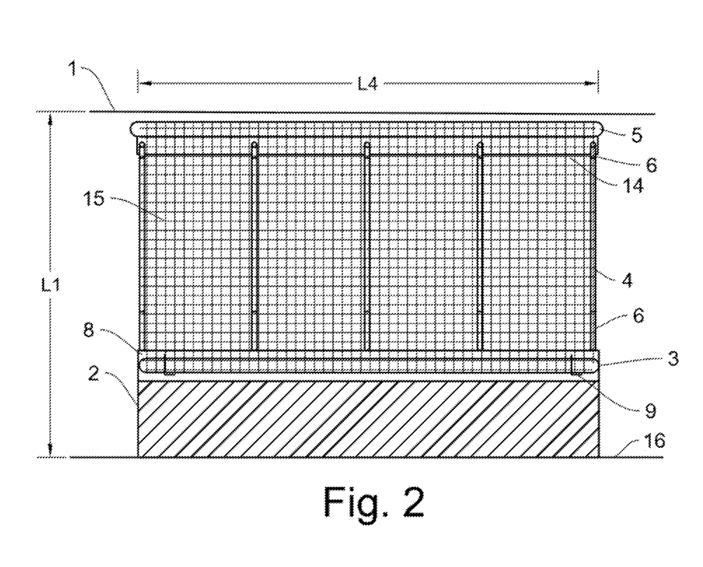

FIGS. 1-2 show important features of the greenhouse design.

### ITEM DESCRIPTION

1 Rear wall—6′-0″ high; concrete masonry unit (CMU), chain-link, or wood
2 Front wall—8″ to 16″ high base; CMU, wood, or metal
3 Lower Micro mesh roller pipe or tube (PVC Pipe)
4 Frame—¾″ cross linked polyethylene plastic tubing (PEX) or metal tube
5 Upper cover rollup pipe (PVC Pipe)
6 Dowel support
7 Soil level
8 Stained 2″×6″ wood
9 Hook support for lower cover rollup
11 Insulation board
12 Ground covering liner—black 6 mil PVC sheet
13 Wall hook support for cover rollup
14 Treated wood 2″×4″
15 Rollup cover for shade, screen, and insulating frost cover for the enclosed space (Only shown in FIG. 2, but includes the two ends of the enclosed space)
16 Ground elevation
17 Mulch or a mulch/soil combination
18 Irrigation piping
19 Soil
L1 Height of enclosed space (Example: Six feet High)
L2 Width between rear wall and inside front wall (Example: Two to four feet wide)
L3 Height of soil above ground (Example: Sixteen inches high)
L4 Length of enclosed space (Example: Eight feet wide)

In FIG. 1, the rear wall 1 is preferably made from concrete. The rear wall dimension L1 is the height above the ground.

The front wall 2 is preferably made from concrete.

The lower micro mesh roller 3 is preferably a PVC pipe 10. The pipe 10 rests on a hook 9 that is imbedded into a 2×6 wooden board 8. The rollup cover 15 is supported by a spaced pipe frame 4 made of PEX. Dowel support rods 6 are used to support the PEX pipe on either end. At the top of the design, there is another hook 13, and an upper cover roll up 5 that is also made from PEX pipe 10.

An insulation board 11 is used to control the temperature environment for the plants to grow. In this embodiment, it is positioned on the surface of the rear wall 1 to prevent the rear wall concrete from creating a significant temperature swing in the urban garden.

The cover 15 is a mesh (micro mesh) or a clear plastic. Alternately, an insulating-shade cover is utilized to regulate temperature and the amount of light on the plants.

An irrigation drip system 18 provides watering through a lengthwise pipe and attached orifices that are spaced at intervals. An on/off valve (not shown) is used to turn the water on and off based on the settings of a timer. The greenhouse preferably has a drain valve (not shown) on one end, to provide a drain for an any excess plant watering.

The enclosure preferably includes cedar wood planks for the ends that enclose the garden soil. In an alternate embodiment, the garden is a free standing box, with four sides enclosed by cedar planks. The frame is preferably a size that fits conveniently with standard lengths for the framework including: 4′×4′ standard unit size, 4′×8′ larger unit, or a 4′×12′ elongated size. Alternately the sizes for a CMV box would be 2′×4′, 2′×8′, 2′×12′, 4′×4′, 4′×8′ sizes.

In an alternate embodiment, the design may be used in less developed places in the world, and in this case a round cross section is preferable which would be about 2′ in diameter×4′ long.

The use of a micro mesh cover is desirable to provide insect prevention and a good air flow environment for the plants.

In a preferred embodiment, the garden is located on a patio for a high-rise apartment situation. In another embodiment, the garden is located on a single owner residential property.

The garden cover rolls up by use of a pipe 5 to improve and simplify the design. The lower pipe 3 provides a weighted edge so that the cover hangs straight. The cover can be raised or lowered as needed, by rotating and securing the upper pipe 5. If a frost cover is used, it preferably has at least a 4″ gap between the plants and the cover. A frost cover is useful for high elevation areas due to the extended cold season.

The advantages of the urban greenhouse include:
1. It is a high-tech tunnel growing machine for backyards and high rise condominiums patios.
2. It uses 100% organics that decompose to provide a warm environment to allow the growing season to extend gardening to areas with five to six months of winter.
3. Uses 80% less water due to the cover
4. Allows harvest production increase of up to five times over commercial farming. This provides all the gardening food a family of four will need to live.
5. Garden plant protection for insects, weeds, birds, frost, snow, wind, and animal digging.

The annual US market for vegetable gardening is a $5 billion a year industry in the United States. This garden can provide healthy fresh for 6 million new millennial gardeners each year.

The embodied greenhouse grows food year-round and can support most all the fresh produce needed for a family of four without limitations.

The patent pending system reduces water consumption by 80%. This is critical since women and children in the 3rd world countries often spend 6-7 hours a day transporting water. With this system their efforts can be reduced to 90 minutes a day.

The embodied greenhouse uses CO₂ and fertilizer injection through the irrigation piping 18. Alternately, mushrooms that create CO₂ could be added to the soil, or placed in containers inside the greenhouse. An increase in CO₂ levels during photosynthesis allowing plants to produce 30% greater yields. The plants have robust growth in the embodied system.

In addition, a harvest system called “Shearing” is used to partly shear the garden plants (like salad mix, celery, beets, bok choy, spinach, and 32 other vegetables and fruits) by trimming the outside leaves only to the extent that still allows the plants to continue to grow. This method can increase production up to five times vs commercial farming that removes plants during harvesting.

Advantages include:
1. Use 80% less water
2. Grow 50% more food 40% faster
3. Supplies all the gardening food a family of four will need.
4. year-round growth
5. Includes drip irrigation, frost cover, auto fertilizer, water timer, CO2 addition, ground moisture barrier, seed tapes, runs on AA batteries, eliminates weeding and insecticides, protection from birds-hail-frost.

While various embodiments of the present invention have been described, the invention may be modified and adapted to various operational methods to those skilled in the art. Therefore, this invention is not limited to the description and figure shown herein, and includes all such embodiments, changes, and modifications that are encompassed by the scope of the claims.

I claim:

1. An enclosed greenhouse designed to provide a crop growing environment in an urban setting comprising:
a. a rear concrete wall located at the rear of said enclosed greenhouse,
b. a front concrete wall located at the front of said enclosed greenhouse,
c. a left side and a right side of said enclosed greenhouse,
d. a rectangularly shaped cover overlaid on top of curved pipe,
e. wherein said curved pipe reaches between said rear concrete wall and said front concrete wall,
f. a liner between said rear concrete wall and said front concrete wall,
g. wherein a length of said cover is adjusted by a roll up pipe that is supported by hooks,
h. an irrigation piping, and
i. an insulating board covering said rear concrete wall.

2. The enclosed greenhouse according to claim 1 wherein plant within said enclosed greenhouse are watered by said irrigation piping.

3. The enclosed greenhouse according to claim 2 wherein CO₂ is injected periodically into said irrigation piping.
